(19) United States
(12) Patent Application Publication
(10) Pub. No.: US 2013/0175850 A1
(43) Pub. Date: Jul. 11, 2013

(54) WHEEL COVER STRUCTURE FOR A VEHICLE

(71) Applicant: Choung Sub Ryu, Incheon (KR)

(72) Inventor: Choung Sub Ryu, Incheon (KR)

(21) Appl. No.: 13/809,950

(22) PCT Filed: Jul. 8, 2010
(86) PCT No.: PCT/KR2010/004441

§ 371 Date: Jan. 14, 2013

(30) Foreign Application Priority Data
Jul. 8, 2009 (KR) 10-2009-0062139

(51) Int. Cl. B60B 7/20

(52) U.S. Cl. CPC B60B 7/20
USPC 301/37.25

(57) ABSTRACT

The present invention relates to a wheel cover structure for a vehicle, comprising: a wheel cover arranged over a front surface of a vehicle wheel; a rotation support unit interposed between the vehicle wheel and the wheel cover to support the wheel cover such that the vehicle wheel is maintained in a decelerated rotating state; a rotating case which is fixed at a front surface of the wheel cover, and which stores a fluid therein; a floating plate which is equipped with an air container for providing floating force in order to maintain the floating plate at a constant position during travel, and which is rotatably supported within the rotating case; and a plate including a design, arranged on a front surface of the rotating case, supported at the floating plate, and having a picture or a design printed thereon.

### CROSS-REFERENCE TO RELATED APPLICATION

This application claims the benefit of Korean Patent Application No. 10-2009-0062139, filed on Jul. 8, 2009 in the Korean Intellectual Property Office, the disclosure of which is incorporated herein by reference.

### FIELD OF THE INVENTION

The present invention relates to a wheel cover structure for a vehicle, more particularly, a wheel cover structure for a vehicle wherein a design plate can always maintain its constant position during travel of vehicle while not influenced by rotation of a vehicle wheel and eccentricity is not present in internal structure and replacement of the design plate is convenient and design plates of various forms can easily applied, thus various designs can be provided in accordance with user's taste.

### DESCRIPTION OF RELATED ART

In general, a vehicle is utilized for transportation means, however, in recent, as cultural level of users of vehicle is raised, an design aspect of vehicle is regarded as of great importance in addition to functionality of vehicle as transportation means, and it is an actual circumstance that vehicles of various designs are annually launched which can meet the desires of users.

In accordance with such a trend, a wheel cover fitted on a vehicle wheel is also produced with various designs, and logos, emblems or various types of designs etc. are designed on a front surface of the wheel cover, whereby an advertising effect of vehicle and decorative effect as accessory can be obtained.

However, since the wheel cover rotates at a high speed together with the vehicle wheel during travel of vehicle, the design on the wheel cover may not be identified, so the design on the wheel cover may be identified only during stop of vehicle.

Therefore, the applicant has filed an application relating to a wheel cover wherein even if the wheel of vehicle rotate, a design plate mounted on the wheel does not rotate and can be maintained in a constant direction, which wheel cover is disclosed in Korean Publication Patent No. 2007-0030681 titled “wheel cover structure for automobile”.

The wheel cover structure for a vehicle comprises a protective case body fixed on a front surface of the vehicle wheel; rotating case body and rotating case cover which have a floating chamber containing liquid therein and are fixed inside the protective case body through a bearing; a design plate which is rotatably fixed inside the floating chamber and has picture or pattern formed thereon; a floating plate which is equipped with an air chamber on one side and is coupled with the design plate; and a protective case cover which finishes the protective case on an outermost side.

Here, the rotating case cover and the protective case cover are made of transparent material so that the design plate is visible from the outside, and liquid enclosing the design plate should also consist of transparent material.

However, the wheel cover structure for a vehicle has problems that the design plate is arranged together with the liquid inside the protective case cover and rotating case cover, therefore, the design plate can be identified only when the protective case cover and rotating case cover each made of transparent material and transparent liquid are necessarily provided and since the design plate is not protruded toward the outside, the design plate cannot be identified from the lateral side of vehicle.

Furthermore, there are also problems that for replacing the design plate, the entire rotating case has to be replaced, thereby causing a high cost and since the design plate is arranged inside the rotating case, a protrusion-type design plate is difficult to use.

### SUMMARY OF THE PRESENT INVENTION

The present invention has been devised in order to solve the above-mentioned problems, and its object is to provide a wheel cover structure for a vehicle wherein the design plate maintains its constant position during travel of vehicle while not influenced by rotation of the vehicle wheel, thus the design plate can be easily identified and by arranging the floating plate without eccentricity, safety of vehicle is ensured even at the time of failure of bearing and leak of liquid and by arranging the design plate outside the rotating case, the design plate can be easily and conveniently replaced, thus the design plates of various forms can easily applied.

The present invention for achieving the above-mentioned object is characterized in that it comprises a wheel cover arranged on a front surface of a vehicle wheel; a rotation support unit arranged between the vehicle wheel and the wheel cover and supporting the wheel cover such that the wheel cover is maintained in a decelerated rotating state relative to the vehicle wheel; a rotating case which is fixed to a front surface of the wheel cover and in which fluid is stored; a floating plate which is equipped with an air container for providing floating force in order to maintain the floating plate in a constant position during travel of the vehicle and which is rotatably supported within the rotating case; and a design plate arranged on a front surface of the rotating case, supported by the floating plate, and having picture or design formed on the design plate.

Furthermore, the present invention is characterized in that the rotation support unit comprises a fixed frame fixed to the front surface of the vehicle wheel; and a rotatable frame which is rotatably supported on a front surface of the fixed frame and to a rear surface of which the wheel cover is fixed.

Furthermore, the present invention is characterized in that it further comprises a rotation shaft which is arranged at a central portion of the floating plate and extends through the rotating case and to which the design plate is fixed.

Furthermore, the present invention is characterized in that it further comprises a support bearing arranged on the front surface of the rotating case and rotatably supporting the design plate; first magnet members which are arranged on the rear surface of the design plate; and second magnet members which are arranged on the floating plate while corresponding to the first magnet members and are magnetically coupled with the first magnet members.

Furthermore, the present invention is characterized in that the floating plate and the design plate further comprise a weight having the weight corresponding to the respective first and second magnet members so as not to have eccentricity.

Furthermore, the present invention is characterized in that the wheel cover is formed with a plurality of wing-shaped frames in such a manner that through grooves are formed along the circumference of the wheel cover.

As described above, the wheel cover structure for a vehicle according to the present invention has effects that the design plate maintains its constant position during the travel of vehicle while not influenced by the vehicle wheel, thus the design plate is clearly visible and since replacement of the design plate is convenient, a user can easily optionally replace various designs, and protrusion-type design plates of various forms can be applied, thus decorative or advertising effect can be provided through the wheel cover structure and the design plates of various forms can be provided in accordance with user's taste.

### BRIEF DESCRIPTION OF THE DRAWINGS

FIG. 1 is an exploded perspective view showing constructions of wheel cover structure for a vehicle according to a first example of the present invention.

FIG. 2 is a sectional view showing the constructions of wheel cover structure for a vehicle according to the first example of the present invention.

FIG. 3 is an exploded perspective view showing constructions of wheel cover structure for a vehicle according to a second example of the present invention.

FIG. 4 is a sectional view showing the constructions of wheel cover structure for the vehicle according to the second example of the present invention.

### MODE FOR CARRYING OUT THE INVENTION

In the following, examples of the present invention will be described in detail, however, the present invention is not limited to the following examples as long as its spirit is not deviated from.

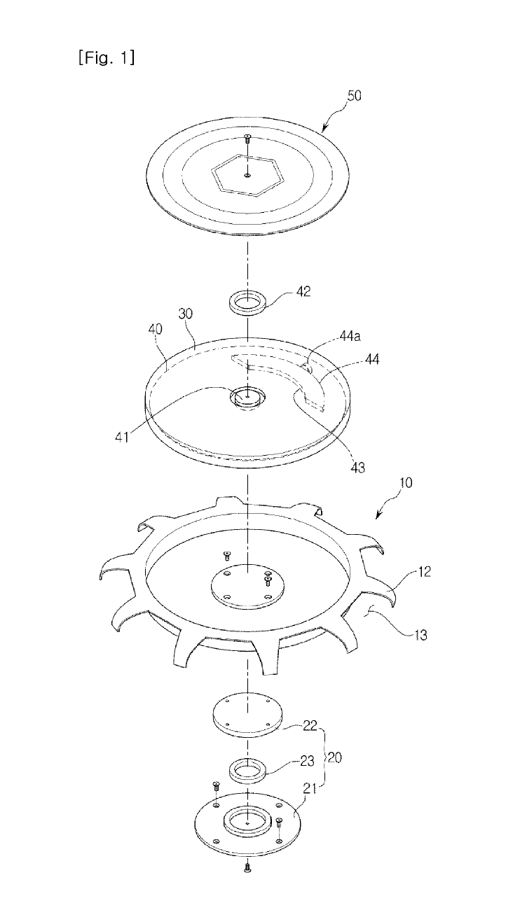

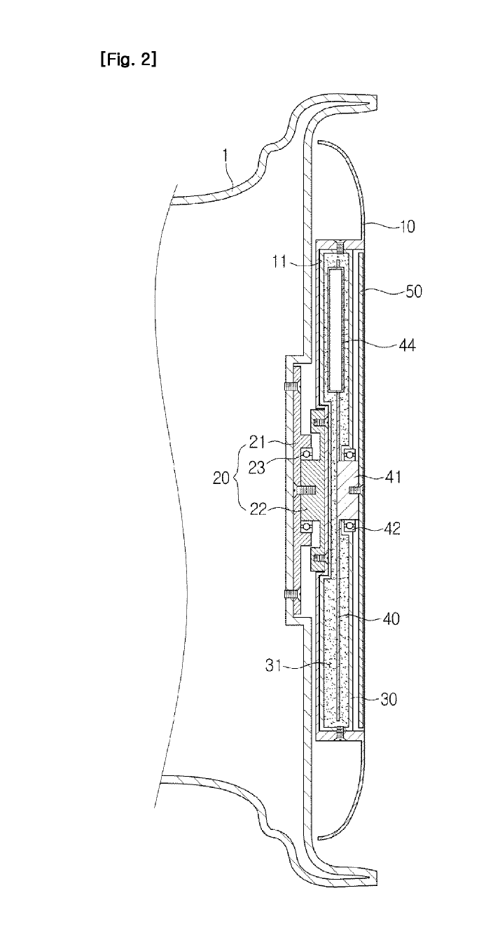

FIG. 1 is an exploded perspective view showing constructions of wheel cover structure for a vehicle according to a first example of the present invention, and FIG. 2 is a sectional view showing the constructions of wheel cover structure for a vehicle according to the first example of the present invention.

With reference to FIGS. 1 and 2, the wheel cover structure for a vehicle according to the first example of the present invention comprises a wheel cover (10) arranged on a front surface of a vehicle wheel (1); a rotation support unit (20) arranged between the vehicle wheel (1) and the wheel cover (10) to support the wheel cover (10) such that the wheel cover is maintained in a decelerated rotating state relative to the vehicle wheel (1); a rotating case (30) which is fixed to a front surface of the wheel cover (10) and in which fluid is stored; a floating plate (40) which is equipped with an air container (45) for providing floating force in order to maintain the floating plate in a constant position during travel of the vehicle and which is rotatably supported within the rotating case (30); and a design plate (50) arranged on a front surface of the rotating case (30), supported by the floating plate (40), and having a picture or a design formed on the design plate.

Detailed description will be given of constructions of respective components of the wheel cover structure for a vehicle according to the first example. The wheel cover (10) is arranged on the front surface of the vehicle wheel (1), and an insertion recess (11) for insertion of the rotating case (30) is formed in a central portion of the front surface.

The wheel cover (10) may be formed with a plurality of wing-shaped frames (13) in such a manner that through grooves (12) are formed along the circumference of the cover. Air may be easily injected into a tire(not illustrated) arranged on the vehicle wheel (1) through the through grooves (12), and these through grooves provide aesthetic feeling when the wheel cover (10) rotates at a low speed during travel of the vehicle and simultaneously may impart air-cooling effect on the vehicle wheel (1) and a wheel brake lining (not illustrated) arranged inside the vehicle wheel (1).

The rotation support unit (20) rotatably fixing the wheel cover (10) to the front surface of the vehicle wheel (1), and comprises a fixed frame (21) fixed to the front surface of the vehicle wheel (1) and a rotatable frame (22) which is rotatably supported on a front surface of the fixed frame (21) by means of a bearing (23) and to a rear surface of which the wheel cover (10) is fixed.

With such constructions, the rotation support unit (20) supports the wheel cover (10) such that the cover can rotate while maintaining a lower speed relative to rotation of vehicle wheel (1) rotating at a high speed during the travel of the vehicle, wherein the rotation support unit enables the wheel cover (10) to maintain a rotation of 3%-5% or less relative to a rotation of 100% of the vehicle wheel (1).

The rotating case (30) is fixed in the insertion recess (11) of the wheel cover (10) and rotates together with the wheel cover (10) during the travel of the vehicle, wherein liquid (31) is stored inside the rotating case (30) and the floating plate (40) is fixed thereinside, as will be described later.

In this connection, for the liquid (31) inside the rotating case (30), oil or anti-freezing solution should be used which has a low viscosity and does not experience variation of its properties due to heat.

The floating plate (40) is rotatably fixed inside the rotating case (30), wherein a rotation shaft (41) extending through a front surface of the rotating case (30) is formed at a central portion of the floating plate (40) and the rotation shaft (41) is rotatably supported inside the rotating case (30) through a bearing (42).

A through portion (43) of predetermined shape is formed at one side of the floating plate (40), and the air container (44) with a cap (44a) is joined in the through portion (43). The air container (44) of the floating plate (40) provides the floating force in the liquid (31) inside the rotating case (30) to enable the floating plate (40) to be always in a constant position without rotation.

In this connection, the floating plate (40) may be shaken by flow of the liquid if the plate is formed with a light weight, therefore, it is preferred that the plate is formed with a weight for overcoming the flow of the liquid.

Moreover, the floating plate (40) is constructed in such a way that the weight of the air container (44) is equal to the weight of a side opposite the air container (44) considering a safety of the vehicle, thus the floating plate (40) is wholly balanced in its weight.

That is to say, even if the liquid inside the rotating case (30) leaks out since the case is broken during the travel of the vehicle or even if the floating plate (40) rotates due to failure since the bearing (42) of the floating plate (40) becomes abnormal, since the floating plate (40) does not have eccentricity, the travel of the vehicle is not influenced, thus the vehicle can safely travel even at the time of failure.

The design plate (50) has logo and emblem or various types of design etc. designed on its front surface, thereby serving for decoration or advertisement, wherein the design plate (50) is fixed to the rotation shaft (41) of the floating plate (40) protruding from the front surface of the rotating case (30) to keep its constant position together with the floating plate (40) without rotation.

With such constructions, the design plate always maintains its constant position and thus can be easily identified, and since the design plate is arranged outside the rotating case, the plate can be easily and conveniently replaced, whereby various types of design plates can be easily applied.

Next, description will be given of operational state of wheel cover structure for a vehicle constructed as above according to the first example of the present invention.

With reference to FIG. 2, if the vehicle starts to be driven to travel, the vehicle wheel (1) mounted with the tire(not illustrated) rotates and thus wheel cover (10) also rotates, wherein the wheel cover (10) rotates while maintaining a low speed due to the rotation support unit (20) mounted between the vehicle wheel (1) and the wheel cover (10).

As the wheel cover (10) rotates, the rotating case (30) fixed to the wheel cover (10) also rotates, and the floating plate (40), which is rotatably fixed inside the rotating case (30) containing the liquid (31) therein, does not rotate due to the floating force of the air container (44) and always maintains its constant position.

That is to say, the part of the floating plate (40) in which the air container (44) is arranged receives the floating force in the liquid (31) and thus is always positioned on a upper side of the interior of the rotating case (30). Therefore, even if the rotating case (30) rotates, the part can maintain its upper position due to continuous application of the floating force.

Since the design plate (50) arranged on the front surface of the rotating case (30) is coupled to the floating plate (40) inside the rotating case (30), the design plate always maintains its constant position together with the floating plate (40).

In the following, description will be given of constructions of wheel cover structure for a vehicle constructed as above according to a second example of the present invention.

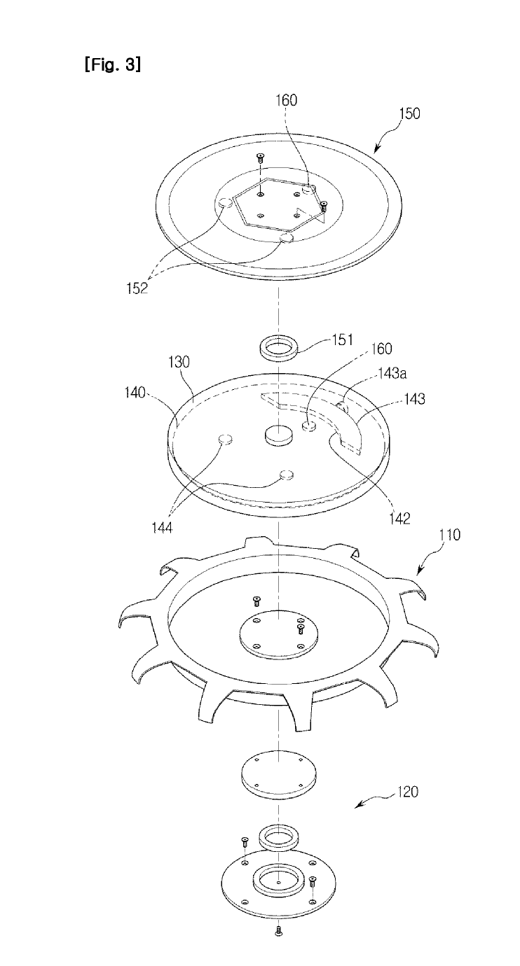

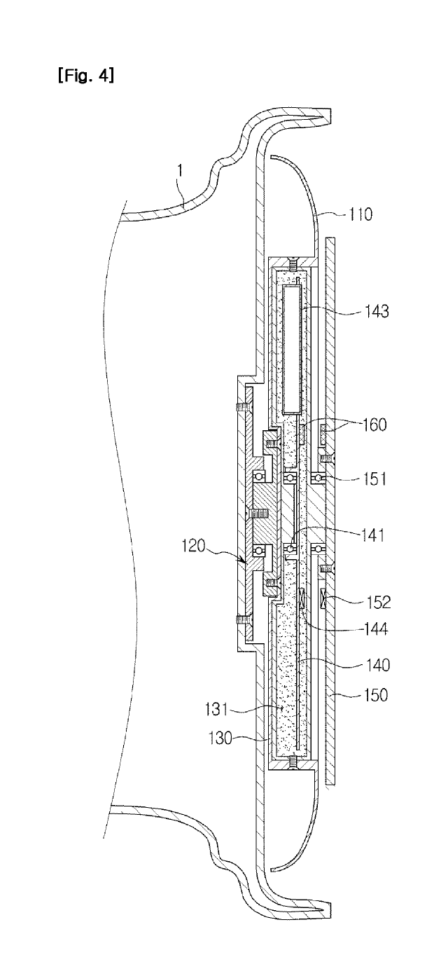

FIG. 3 is an exploded perspective view showing constructions of wheel cover structure for a vehicle according to the second example of the present invention, and FIG. 4 is a sectional view showing the constructions of wheel cover structure for the vehicle according to the second example of the present invention.

With reference to FIGS. 3 and 4, the wheel cover structure for a vehicle according to the second example of the present invention comprises a wheel cover (110) arranged on a front surface of the vehicle wheel (1); a rotation support unit (120) arranged between the vehicle wheel (1) and the wheel cover (110) to support the wheel cover (110) such that the wheel cover is maintained in a decelerated rotating state relative to the vehicle wheel (1); a rotating case (130) which is fixed to a front surface of the wheel cover (110) and in which fluid is stored; a floating plate (140) which is equipped with an air container (143) for providing floating force in order to maintain the floating plate in a constant position during the travel of the vehicle and with second magnet members (144) on the other side and which is rotatably supported within the rotating case (130); and a design plate rotatably fixed to a front surface of the rotating case (130) and, on one side, equipped with first magnet members (152) corresponding to the second magnet members (144) and having a picture or a design formed on the design plate.

Here, constructions of the wheel cover (110), rotation support unit (120) and rotating case (130) of the wheel cover structure for a vehicle according to the second example of the present invention are identical to those of the first example described above.

The floating plate (140) is rotatably supported inside the rotating case (130) through a bearing (141), and in order to enable the floating plate (140) to always maintain its constant position inside the rotating case containing liquid (131) therein through the floating force, a through portion (142) of predetermined shape is formed at one side of the floating plate (140), and an air container (143) with a cap (143a) is joined in the through portion (142).

The design plate (150) is rotatably arranged on the front surface of the rotating case (130), wherein a support bearing (151) rotatably supporting the design plate (150) is arranged on the front surface of the rotating case (130) and the first magnet members (152) are arranged on the rear surface of the design plate (150).

The second magnet members (144) magnetically coupled with the first magnet members (152) of the design plate (150) are also arranged on the part of the floating plate (140) corresponding to the first magnet members (152) of the design plate (150).

Next detailed description is about the design plate (150) and floating plate (140). A pair of first magnet members (152) are arranged on one side of the rear surface of the design plate (150) in such a manner that S and N poles of the magnet members face the rear surface, and a pair of second magnet members (144) corresponding to the pair of first magnet members (152) are also arranged on one side of the front surface of the floating plate (140) are in such a manner that N and S poles of the magnet members face the front surface. Therefore, the first magnet members (152) of the design plate (150) and the second magnet members (144) of the floating plate (140) are arranged in such a manner that different poles face each other, thus the design plate and the floating plate are fixed to each other by magnetic force.

At this time, even if the design plate (150) is forcedly rotated by external force, the plate is returned to its original position since the pair of first magnet members (152) of the design plate (150) meet the pair of second magnet members (144) of the floating plate (140) with the same polarities, thus N pole of the first magnet members meets N pole of the second magnet members and S pole of the first magnet members meets S pole of the second magnet members, whereby repulsive magnetic force is generated.

Here, the positions of first magnet members (152) and second magnet members (144) may be changed depending on structures of the design plate (150) and the floating plate (140).

The pair of first magnet members (152) and the pair of second magnet members (144) may be each arranged with the same polarity only, wherein the first magnet members (152) arranged on the design plate (150) may each have N pole and the second magnet members (144) arranged on the floating plate (140) may each have S pole, whereby different poles face each other, thus the design plate and the floating palate can be fixed to each other by the magnetic force.

A weight (160) corresponding to the weight of the second magnet members (144) is arranged on a side opposite the second magnet members (144) of the floating plate (140), whereby the floating plate (140) does not have eccentricity, and a weight (160) corresponding to the weight of the first magnet members (152) is also arranged likewise on the design plate (150).

With such constructions, by fixing the design plate (150) to the floating plate (140) utilizing the magnetic force of the first magnet members (152) and the second magnet members (144), the design plate (150) can be also maintained in its constant position together with the floating plate (140) which is always maintained in its constant position.

Next, description will be given of operational state of wheel cover structure for a vehicle according to the second example of the present invention.

With reference to FIG. 3, the rotation support unit (110), the wheel cover (120), the rotating case (130) and the floating plate (140) are moved in the same operational state as that of the first example, and the design plate (150) arranged on the front surface of the rotating case (130) is coupled with the second magnet members (144) of the floating plate (140) through the first magnet members (152) to always maintain its constant position together with the floating plate(140).

As described above, the wheel cover structure for a vehicle according to the present invention has effects that the design plate maintains its constant position during the travel of vehicle while not influenced by rotation of the vehicle wheel, thus the design plate is clearly visible and since replacement of the design plate is convenient, a user can easily optionally replace various designs, and protrusion-type design plates of various forms can be applied, thus decorative or advertising effect can be provided through the wheel cover structure and the design plates of various forms can be provided in accordance with user's taste.

It is obvious to persons having ordinary skill in the art that the present invention may be variously substituted or modified without departing from the technical spirit thereof, so the present invention is not limited to the examples as described above and the attached drawings.

What is claimed:

1. A wheel cover structure for a vehicle comprising:
a wheel cover arranged on a front surface of a vehicle wheel;
a rotation support unit arranged between the vehicle wheel and the wheel cover and supporting the wheel cover such that the wheel cover is maintained in a decelerated rotating state relative to the vehicle wheel;
a rotating case which is fixed to a front surface of the wheel cover and in which fluid is stored;
a floating plate which is equipped with an air container for providing floating force in order to maintain the floating plate in a constant position during travel of the vehicle and which is rotatably supported within the rotating case; and
a design plate arranged on a front surface of the rotating case, supported by the floating plate, and having picture or design formed on the design plate.

2. The wheel cover structure for a vehicle according to claim 1, wherein the rotation support unit comprises a fixed frame fixed to the front surface of the vehicle wheel; and a rotatable frame which is rotatably supported on a front surface of the fixed frame and to a rear surface of which the wheel cover is fixed.

3. The wheel cover structure for a vehicle according to claim 1, further comprising a rotation shaft which is arranged at a central portion of the floating plate and extends through the rotating case and to which the design plate is fixed.

4. The wheel cover structure for a vehicle according to claim 1, further comprising:
a support bearing arranged on the front surface of the rotating case and rotatably supporting the design plate;
first magnet members which are arranged on the rear surface of the design plate; and
second magnet members which are arranged on the floating plate while corresponding to the first magnet members and are magnetically coupled with the first magnet members.

5. The wheel cover structure for a vehicle according to claim 4, wherein the floating plate and the design plate further comprise a weight having the weight corresponding to the respective first and second magnet members so as not to have eccentricity.

6. The wheel cover structure for a vehicle according to claim 1, wherein the wheel cover is formed with a plurality of wing-shaped frames in such a manner that through grooves are formed along the circumference of the wheel cover.
